(19) United States
(12) Patent Application Publication
(10) Pub. No.: US 2018/0114067 A1
(43) Pub. Date: Apr. 26, 2018

(54) APPARATUS AND METHOD FOR EXTRACTING OBJECTS IN VIEW POINT OF MOVING VEHICLE

(71) Applicant: SAMSUNG SDS CO., LTD., Seoul (KR)

(72) Inventors: Ki-Sang KWON, Seoul (KR); Du-Won PARK, Seoul (KR); Min-Kyu KIM, Seoul (KR)

(73) Assignee: SAMSUNG SDS CO., LTD., Seoul (KR)

(21) Appl. No.: 15/789,126

(22) Filed: Oct. 20, 2017

(30) Foreign Application Priority Data
Oct. 26, 2016 (KR) 10-2016-0140459

(51) Int. Cl. G06K 9/00

(52) U.S. Cl. CPC G06K 9/00711; B60R 21/34; G06K 9/00805

(57) ABSTRACT

Disclosed are an apparatus for detecting an object. The apparatus for detecting an object includes a processor configured to execute processor-executable instructions to acquire a video of a target region corresponding to a movement direction of a mobile body, extract one or more interesting points of one or more objects in the video acquired and extract one or more motion vectors according to positional changes of the one or more interesting points in the video, select one or more reference points having fixed positions in the target region and set one or more reference vectors of the one or more reference points, respectively, according to positional changes of the one or more reference points in the video, and detect a moving object among the one or more objects in the video by comparing the one or more motion vectors extracted with the one or more reference vectors set.

### CROSS-REFERENCE TO RELATED APPLICATION

This application claims priority to and the benefit of Korean Patent Application No. 10-2016-0140459, filed on Oct. 26, 2016, the disclosure of which is incorporated herein by reference in its entirety.

### BACKGROUND

### 1. Field

The present disclosure relates to a technology for detecting a moving object on the basis of a video, and more particularly, to an apparatus for detecting an object.

### 2. Discussion of Related Art

According to related art, when a driver drives a transporting means such as a vehicle, he or she should recognize objects around the vehicle by watching the front or rear of the vehicle or through videos of the front or rear to prevent a collision with surrounding objects. This distracts the driver's attention, and thus there is a high risk of accidents. Accordingly, a sensor-based object detection method is frequently being used these days. However, according to the sensor-based object detection method of measuring a distance from a nearby object with a lidar, a radar, or ultrasonic measurement equipment and alarming a driver, it is difficult for a driver to intuitively know the presence of a nearby object, and there is a limitation in a sensing distance. Also, such a sensor-based object detection method involves high costs, and there is a blind spot that is difficult to recognize with a sensor alone.

Consequently, it is necessary to develop a technology for efficiently providing accurate information of surrounding objects to a driver in a running vehicle.

### SUMMARY

The present disclosure is directed to rapidly detecting a moving object at low costs in a running vehicle, unmanned equipment, or the like.

According to an aspect of the present disclosure, there is provided an apparatus for detecting an object, the apparatus including: a processor configured to execute processor-executable instructions to: acquire a video of a target region corresponding to a movement direction of a mobile body; extract one or more interesting points of one or more objects in the video acquired and extract one or more motion vectors according to positional changes of the one or more interesting points in the video; select one or more reference points having fixed positions in the target region and set one or more reference vectors of the one or more reference points, respectively, according to positional changes of the one or more reference points in the video; and detect a moving object among the one or more objects in the video by comparing the one or more motion vectors extracted with the one or more reference vectors set.

The processor may be further configured to: set a focus of expansion in the video on the basis of the degree of a turn of the movement direction made by the mobile body, and set the one or more reference vectors on the basis of distances between the focus of expansion and the one or more reference points.

The processor may be further configured to decrease magnitudes of the one or more reference vectors of the one or more reference points in response to the distance between the focus of expansion and the one or more reference points decreasing.

Magnitudes of the one or more reference vectors of the one or more reference points correspond to magnitudes of a Gaussian error function.

The processor may be further configured to set the one or more reference vectors to correspond to a movement speed of the mobile body.

The processor may be further configured to set the one or more reference vectors, wherein maximum values of magnitudes of the one or more reference vectors correspond to a speed of the mobile body.

The processor may be further configured to detect the moving object by comparing magnitudes of the one or more motion vectors extracted and magnitudes of the one or more reference vectors set corresponding to positions of the one or more motion vectors, respectively.

The processor may be further configured to detect an object corresponding to an extracted motion vector as the moving object when a difference between a magnitude of the motion vector and a magnitude of a reference vector corresponding to a position of the motion vector in the video is equal to or higher than a predetermined value.

According to another aspect of the present disclosure, there is provided a method for detecting an object, the method including: acquiring a video of a target region corresponding to a movement direction of a mobile body; extracting one or more interesting points of one or more objects in the video, and extracting one or more motion vectors according to positional changes of the one or more interesting points in the video; selecting one or more reference points having fixed positions in the target region, and setting one or more reference vectors of the one or more reference points, respectively, according to positional changes of the one or more reference points in the video; and detecting a moving object among the one or more objects in the video by comparing the one or more motion vectors with the one or more reference vectors.

The method may further include: setting a focus of expansion in the video based on a degree of a turn of the movement direction made by the mobile body, and setting the one or more reference vectors based on distances between the focus of expansion and the one or more reference points.

The method may further include setting the magnitudes of the one or more reference vectors of the one or more reference points to correspond to the distances between the focus of expansion and the one or more reference points.

The method may further include setting magnitudes of the one or more reference vectors to correspond to magnitudes of a Gaussian error function.

The method may further include setting the one or more reference vectors to correspond to a movement speed of the mobile body.

The method may further include detecting the moving object by comparing magnitudes of the one or more motion vectors and magnitudes of the one or more reference vectors corresponding to positions of the one or more motion vectors, respectively.

Maximum values of magnitudes of the one or more reference vectors correspond to a speed of the mobile body.

The method may further include detecting an object corresponding to an extracted motion vector as the moving object when a difference between a magnitude of the extracted motion vector and a magnitude of a reference vector corresponding to a position of the motion vector in the video is equal to or higher than a predetermined value.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram showing a detailed configuration of an apparatus for detecting an object according to an exemplary embodiment of the present disclosure;

FIG. 2 is an example view illustrating a movement of an object shown in a video depending on a movement of a mobile body according to an exemplary embodiment of the present disclosure;

FIG. 3 is an example view illustrating a focus of expansion and motion vectors in a video according to an exemplary embodiment of the present disclosure;

FIG. 4 is an example view illustrating interesting points and motion vectors of a target region according to an exemplary embodiment of the present disclosure;

FIG. 5 is a graph showing a relationship between a steering angle of a mobile body and a magnitude of a reference vector and a relationship between a movement speed of a mobile body and the magnitude of a reference vector according to an exemplary embodiment of the present disclosure;

FIG. 6 is an example view illustrating a method of detecting an object using an apparatus for detecting an object according to an exemplary embodiment of the present disclosure;

FIG. 7 is a flowchart illustrating a method of detecting an object according to an exemplary embodiment of the present disclosure; and

FIG. 8 is a block diagram illustrating an example of a computing environment including a computing apparatus appropriate for use in exemplary embodiments.

### DETAILED DESCRIPTION OF EXEMPLARY EMBODIMENTS

Hereinafter, exemplary embodiments of the present disclosure will be described in detail with reference to the drawings. The following detailed description is provided to help comprehensive understanding of a method, an apparatus, and/or a system disclosed herein. However, this is merely exemplary, and the present disclosure is not limited thereto.

While describing the present disclosure, when it is determined that a detailed description of a known art related to the present disclosure may unnecessarily obscure the gist of the present disclosure, the detailed description will be omitted. Terms which will be described below are defined in consideration of functionality in the present disclosure, which may vary according to an intention of a user or an operator or a usual practice. Therefore, definitions thereof should be made on the basis of the overall contents of this specification. Terminology used herein is for the purpose of describing exemplary embodiments of the present disclosure only and is not intended to be limiting. The singular forms are intended to include the plural forms as well, unless the context clearly indicates otherwise. It should be understood that the terms “comprises,” “comprising,” “includes,” and “including,” when used herein, specify the presence of stated features, numerals, steps, operations, elements, or combinations thereof, but do not preclude the presence or addition of one or more other features, numerals, steps, operations, elements, or combinations thereof.

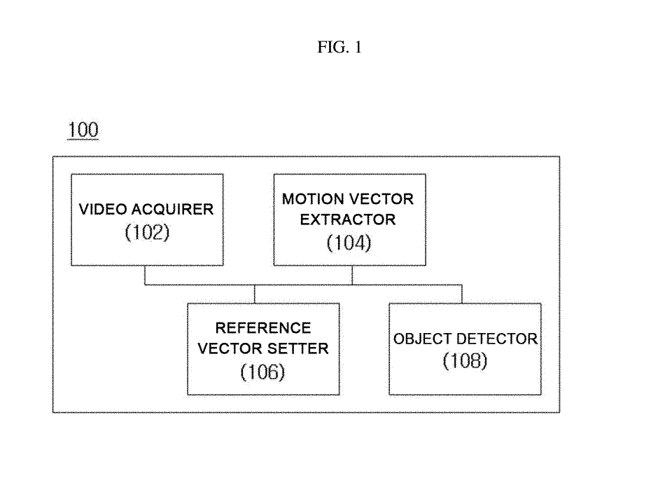

FIG. 1 is a block diagram showing a detailed configuration of an apparatus 100 for detecting an object in a mobile body (referred to as “object-detecting apparatus” below) according to an exemplary embodiment of the present disclosure. As shown in FIG. 1, the object-detecting apparatus 100 according to an exemplary embodiment of the present disclosure includes a video acquirer 102, a motion vector extractor 104, a reference vector setter 106, and an object detector 108.

The object-detecting apparatus 100 according to an exemplary embodiment of the present disclosure is intended to detect a moving object which is likely to collide with a moving mobile body by analyzing a video captured in the mobile body. In exemplary embodiments, a moving object may not only be a vehicle as a transporting means, an unmanned car, and a drone, but may also be any moving object which is capable of capturing a video.

The video acquirer 102 is a module for photographing a target region from the viewpoint of a mobile body. To this end, the video acquirer 102 may include an optical module, such as a camera, a camcorder, or the like, and acquire a video of the target region by photographing a target region corresponding to a movement direction of the mobile body with the optical module. The optical module may be installed to photograph, for example, the front or rear of the mobile body. Meanwhile, the movement direction of the mobile body denotes a direction in which the mobile body is currently moving. The target region is a region to be photographed by the video acquirer 102 and may denote an actual space in which the mobile body exists. In the target region, one or more objects may exist. However, the target region corresponding to the movement direction does not necessarily indicate only a limited region in the movement direction of the mobile body and may indicate a wide region in a movement direction to which a current movement direction may be changed. For example, the target region may be a region which corresponds to a horizontal angle of view of 180 degrees or less with respect to the optical module. Also, the video captured by the video acquirer 102 may be, for example, a set of color images or monochrome images. As will be described below, a resolution for extracting interesting points and reference points of objects existing in the target region is sufficient, and a high resolution is not necessary. Here, an object may be any person or object which exists in the target region and is likely to collide with the mobile body according to a movement of the mobile body. However, an object is not limited thereto and may include an object which does not move in the target region. For example, an object may be a pedestrian, a vehicle, a bicycle, and the like.

The motion vector extractor 104 is a module for extracting a positional change of an object in the video of the target region. According to an exemplary embodiment, the motion vector extractor 104 may extract interesting points from one or more objects included in the video. An interesting point is a point representing a unique appearance of an object and may be easily identified even when the object changes in shape, size, or position. For example, an interesting point may be a corner point, an edge, and the like of an object. Also, the motion vector extractor 104 may extract interesting points using Harris corner edge detection, Laplacian edge detection, Sobel edge detection, and the like but is not limited by a specific interesting point detection method. According to an exemplary embodiment, the motion vector extractor 104 may use a preprocessing technique, such as resizing, histogram equation, and the like of the video, to extract interesting points with high accuracy.

The motion vector extractor 104 may extract motion vectors of interesting points according to positional changes of the interesting points in the video caused by a movement of the mobile body. The motion vectors are vectors including movement information of the interesting points in the video. Movement information may include a movement direction and a movement speed of a point. Therefore, the movement direction and the movement speed of the point may be expressed by a direction and a magnitude of a motion vector, respectively. For example, the motion vector extractor 104 may extract a motion vector using optical flow analysis methods, such as the Lucas-Kanade method, the Horn-Schunck method, and the like but is not necessarily limited thereto. An interesting point according to an exemplary embodiment may be one point on the appearance of a specific object, and the motion vector extractor 104 may acquire a motion vector of the object by extracting a motion vector of the interesting point.

The motion vector extractor 104 may extract motion vectors from the video, that is, a plurality of images, of the target region. In other words, the motion vector extractor 104 may determine a positional change of an interesting point in the video by comparing images of the target region captured at consecutive points in time, thereby extracting a motion vector of the interesting point. Here, as mentioned above, the motion vector may include information on a direction and a speed in which the interesting point has moved.

A video of a target region acquired through an optical module, which is installed in a mobile body to photograph the front or rear of the mobile body, may be zoomed in or out according to a movement of the mobile body. Specifically, when a side is photographed in the mobile body while the mobile body is moving straight ahead, all backgrounds of a captured video may uniformly move to the left or right regardless of their positions. However, in a video of the front or rear of the moving mobile body, magnitudes of point-specific motion vectors may differ from each other. For example, in a video of the front of the mobile body which moves straight ahead, a point at the center of the video may be shown not to move, but points closer to the edge of the video may be shown to move more in the video. In this manner, even a fixed point in a target region may be shown to move in a captured video, and the point may move at different speeds according to positions in the video. Accordingly, to accurately detect an object, it is necessary to correct the extracted motion vectors according to positions in the video.

The reference vector setter 106 is a module for setting a reference vector which is a criterion for determining whether an object corresponding to a motion vector extracted from the video is moving. According to an exemplary embodiment, the reference vector setter 106 may set one or more fixed reference points in the target region. The reference points are fixed points in the target region and may be one or more points in an unmoving background of the target region. It is unnecessary to select the reference points from an actual specific object, and virtual points whose positions may be specified in the target region and the video of the target region are sufficient for the reference points. Subsequently, the reference vector setter 106 may set reference vectors according to positional changes of the reference points in the video. In other words, the reference point is actually fixed in a space of the target region but may be shown to move in the video captured in the mobile body. Specifically, the reference vector setter 106 may set the reference vector on the basis of the degree of a turn of the movement direction of the mobile body. The degree of a turn of the movement direction of the mobile body may denote how much a path of the mobile body is bent. Specifically, the degree of a turn of the movement direction may indicate a steering angle of the mobile body. The steering angle may denote an angle at which a spindle of wheels and the like is turned by rotating a steering wheel when the mobile body changes the movement direction. For example, a wider steering angle of the mobile body denotes that the degree of a turn of the movement direction made by the mobile body is large. From now, the degree of a turn of the movement direction and the steering angle will be used together for description.

Reference vectors denote vectors including movement information of reference points in a video. Therefore, reference vectors may be motion vectors corresponding to interesting points of objects which actually do not move in a target region. As described above, a reference vector may vary in direction and magnitude according to a relative position with respect to a focus of expansion. A focus of expansion denotes a point shown to be fixed in a video captured in a mobile body when the mobile body moves toward a specific point. Specifically, when the mobile body moves toward a specific point, the focus of expansion may be shown to be fixed in the video while surroundings of the mobile body may be shown to be expanded outside the video. Also, when the mobile body moves away from the specific point, points surrounding the focus of expansion in the video may be shown to converge on the focus of expansion. A position of such a focus of expansion may be determined according to the degree of a turn of the movement direction made by the mobile body, that is, the steering angle. Meanwhile, the magnitude of the reference vector may be reduced when a reference point corresponding to the reference vector is closer to the focus of expansion. In other words, the reference vector setter 106 may set the focus of expansion first in the video to set the reference vector, and the position of the focus of expansion may be determined according to the steering angle of the mobile body.

Also, the magnitude of the reference vector may be determined on the basis of the speed of the mobile body. According to an exemplary embodiment, the reference vector setter 106 may set the reference vector so that the magnitude of the reference vector increases as the speed of the mobile body is higher. In this manner, the reference vector setter 106 may set the reference vectors on the basis of the steering angle, the speed of the mobile body, or both the steering angle and the speed. A process in which the reference vector setter 106 sets a reference vector will be described in detail below.

The reference vector setter 106 may set the focus of expansion in the video on the basis of the degree of a turn of the movement direction made by the mobile body. Specifically, the focus of expansion in the video may be set on the basis of the steering angle of the mobile body. The focus of expansion may be determined according to the steering angle of the mobile body. According to an exemplary embodiment, the focus of expansion may be present in a region to which the mobile body will turn the movement direction from the center of the video. For example, when the mobile body slightly turns the movement direction to the left of a current movement direction, the reference vector setter 106 may set the focus of expansion to the left of the center of the video. Here, when the degree of a turn of the movement direction made by the mobile body is large, the focus of expansion may deviate far from the center of the video. When the mobile body maintains the current movement direction, that is, when the steering angle of the mobile body is 0, the focus of expansion may be positioned at the center of the video. Also, when the steering angle of the mobile body is the maximum, the reference vector setter 106 may set the focus of expansion outside the video.

Next, the reference vector setter 106 may set reference vectors on the basis of the set focus of expansion according to positions of one or more fixed reference points in the target region. As described above, directions of the reference vectors may be directions in which the reference vectors converge on or diverge from the focus of expansion. Also, magnitudes of the reference vectors may be reduced when the corresponding reference points are closer to the focus of expansion. For example, it is assumed that the focus of expansion is left to the center of the video and the mobile body turns the movement direction towards the focus of expansion. In this case, reference vectors of reference points close to the focus of expansion in the video may show smaller magnitudes than reference vectors of reference points far from the focus of expansion. For example, a reference vector of a reference point at the same position as the focus of expansion may have a magnitude of 0 even when the mobile body moves. In exemplary embodiments, when the video is expressed as a coordinate plane (x, y), a distance between a reference point and the focus of expansion may denote a difference between an x value of the reference point and an x value of the focus of expansion. This is because reference vectors corresponding the reference points having the same x value may have the same magnitude in the video.

According to an exemplary embodiment, the reference vector setter 106 may set the reference vectors so that magnitudes of the reference vectors corresponding to the reference points with respect to distances between the focus of expansion and the reference points in the video are in accordance with a magnitude of the Gaussian error function.

Meanwhile, the reference vector setter 106 may set the magnitudes of the reference vectors in additional consideration of a movement speed of the mobile body. Specifically, when the mobile body moves faster, a positional change of a reference point between two consecutive images may be greater. In other words, a magnitude of a reference vector of a reference point may be determined according to the speed of the mobile body. Even when the movement speed of the mobile body increases, a magnitude of a motion vector of an interesting point corresponding to the focus of expansion may remain 0, but a maximum value of the magnitude of the reference vector may increase. That is, as the speed of the mobile body is higher, a difference in magnitude between a reference vector of a reference point corresponding to the focus of expansion and a reference vector of a reference point far from the focus of expansion may increase.

The object detector 108 is a module for detecting a moving object in the target region on the basis of the corrected motion vectors and the reference vectors in the video. Specifically, the object detector 108 may detect a moving object among objects by comparing the extracted motion vectors and the set reference vectors. More specifically, the object detector 108 may detect a moving object by comparing magnitudes of the extracted motion vectors and magnitudes of the reference vectors corresponding to positions of the motion vectors in the video. In an example, the object detector 108 may set an object corresponding to an extracted motion vector as a moving object when a difference between a magnitude of the extracted motion vector and a magnitude of a reference vector corresponding to a position of the motion vector in the video is a set value or more. Although all objects may be shown to move in a video captured in the moving mobile body, the object detector 108 may compare movements of objects and a background in the video and detect an object whose positional change is remarkably greater or less than the background as an object which is likely to collide with the mobile body.

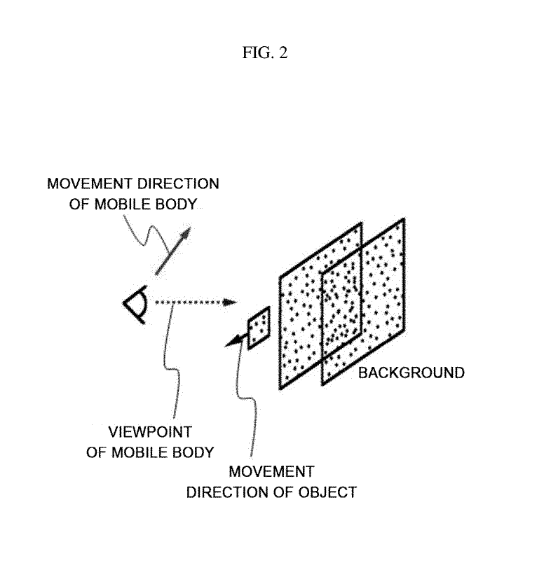

FIG. 2 is an example view illustrating a movement of an object shown in a video depending on a movement of a mobile body according to an exemplary embodiment of the present disclosure.

As shown in FIG. 2, since a mobile body is moving, a background as well as an object may be shown to move in a video captured in the mobile body. According to an exemplary embodiment, when an object move in the opposite direction to the mobile body in a fixed background, the background may be shown to move in a video captured in the mobile body, and the object may be shown to move faster than a movement speed of the background. Therefore, the object-detecting apparatus 100 according to an exemplary embodiment of the present disclosure may detect the object by comparing the movement speed of the background and a movement speed of the object. As described above, the movement speed of the background may be expressed as a magnitude of a reference vector of a reference point, and the movement speed of the object may be expressed as a magnitude of a motion vector of the object. The object-detecting apparatus 100 may detect a moving object at low costs by comparatively analyzing movements of objects in a video of a target region with a movement of a background.

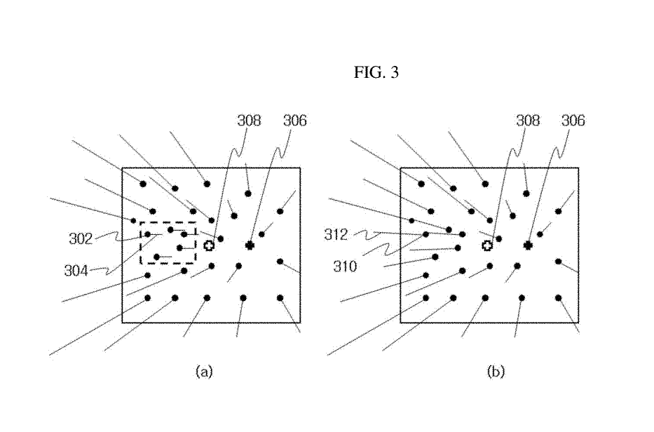

FIG. 3 is an example view illustrating a focus of expansion 306 and motion vectors 304 in a video according to an exemplary embodiment of the present disclosure. FIG. 3 is an example view of a video captured from a viewpoint of a mobile body.

The object-detecting apparatus 100 according to an exemplary embodiment may extract interesting points 302 and the motion vectors 304 corresponding to the interesting points 302 from an object in a target region (see FIG. 3A). Also, the object-detecting apparatus 100 may extract reference points 310 and reference vectors 312 corresponding to the reference points 310 from a background in the target region (see FIG. 3B).

Referring to FIG. 3A, the interesting points 302 of the object are shown. Also, the motion vectors 304 of the interesting points 302 resulting from a movement of the mobile body are separately expressed at the interesting points 302. Longitudinal directions of the motion vectors 304 shown in FIG. 3 denote movement directions of the interesting points 302 displayed in the video, and lengths of the motion vectors 304 denote distances that the interesting points 302 move per set unit time (e.g., a difference in time between frames of the video). In other words, the motion vectors 304 may be a set of paths that the interesting points 302 have moved in the video. However, the interesting points 302 shown in FIG. 3A may be interesting points (start points) in a past video or may be interesting points (end points) in a current video. This may vary according to a setting of the object-detecting apparatus 100. In the present exemplary embodiment, the object may include both a fixed object and a moving object in the target region.

Referring to FIG. 3B, the reference points 310 of the target region are shown. Also, the reference vectors 312 of the reference points 310 resulting from the movement of the mobile body are separately expressed at the reference points 310. In other words, the reference vectors 312 may be motion vectors extracted from the interesting points 302 of the object when the object does not move. The reference vectors 312 may be displayed to converge on or diverge from the focus of expansion 306 when the mobile body moves toward the focus of expansion 306 or back from the focus of expansion 306. This is because, when the mobile body moves toward or back from the focus of expansion 306, a video captured in the mobile body is shown to be zoomed in or out with respect to the focus of expansion 306. Also, reference points 310 close to the focus of expansion 306 in the video may move at lower speeds than reference points 310 far from the focus of expansion 306. In other words, magnitudes of the reference vectors 312 may vary according to distances between the focus of expansion 306 and the corresponding reference points 310 in the video.

The object-detecting apparatus 100 according to an exemplary embodiment of the present disclosure may detect a moving object which is likely to collide with the mobile body by comparing the motion vectors 304 with the reference vectors 312. Specifically, the object-detecting apparatus 100 may compare magnitudes of the motion vectors 304 and magnitudes of the reference vectors 312 corresponding to positions of the motion vectors 304 and detect a motion vector 304 whose magnitude difference is a set value or more. In other words, the object-detecting apparatus 100 may calculate absolute values of differences between the magnitudes of the motion vectors 304 and the magnitudes of the reference vectors 312 at the same positions in the video according to the positions in the video, and may detect a position whose calculated absolute value is the set value or more as a region in which a moving object exists. Comparing FIGS. 3A and 3B, it is possible to see that there are remarkable differences in magnitude between motion vectors 304 in a rectangular region indicated by a broken line and reference vectors 312 in the same region. In this way, the object-detecting apparatus 100 may detect an object corresponding to the region (the broken-line region of FIG. 3A) composed of the detected motion vectors 304 as the object which is likely to collide with the mobile body.

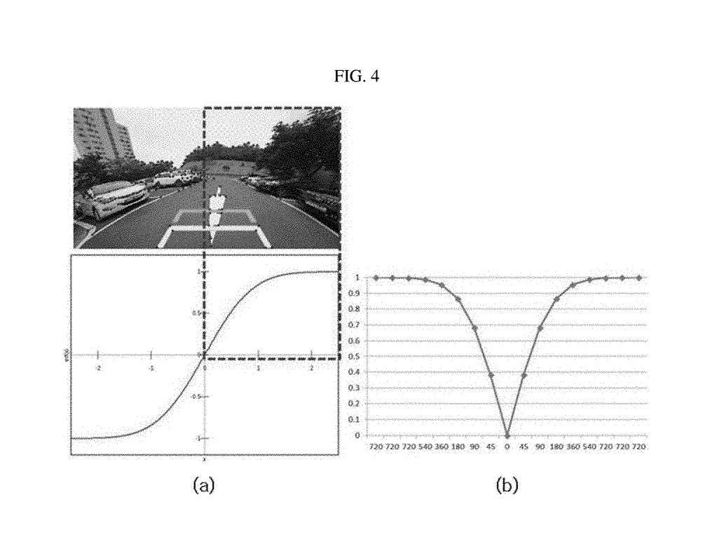

FIG. 4 is an example view illustrating interesting points and motion vectors of a target region according to an exemplary embodiment of the present disclosure.

FIG. 4A is a photograph (up) and a graph (down) showing a relationship between magnitudes of motion vectors and positions of interesting points corresponding to the motion vectors in a video of a target region in which there is no moving object. Since there is no moving object in the target region photographed in FIG. 4A, the interesting points of FIG. 4A may also be reference points, and the motion vectors may also be reference vectors.

First, in the graph (down) of FIG. 4A, the horizontal axis denotes a distance between a reference point and a focus of expansion. In the present exemplary embodiments, when a video is expressed as a coordinate plane (x, y), a distance between a reference point and a focus of expansion may denote a difference between an x value (a value on the horizontal axis) of the reference point and an x value of the focus of expansion. In other words, the horizontal axis of FIG. 4A may denote a position of a fixed point in a coordinate plane in which a focus of expansion (x=0) is the origin. An x value may be set in units of pixels or blocks according to a steering angle. Also, the vertical axis of the graph (down) denotes a magnitude of each reference vector. As can be seen from the photograph (up), a reference vector existing at the edge of the video, that is, a reference vector far away from the focus of expansion (x=0), has a greater magnitude. A magnitude of a reference vector with respect to such a distance between the reference point and the focus of expansion may be in accordance with a magnitude of the Gaussian error function. Specifically, with an increase in the distance between a reference point and the focus of expansion in the video, a magnitude of a reference vector may increase according to the Gaussian error function. The graph shown in FIG. 4A denotes the Gaussian error function. The Gaussian error function may be expressed by Equation 1.

$$erf ( x ) = \frac{2}{\sqrt{π}} {\int }_{0}^{x} {e}^{- {t}^{2}} dt \qquad [ Equation 1 ]$$

(erf(x): the Gaussian error function of x, x: an x value of a reference point in a video, that is, on a coordinate plane in which a focus of expansion (x=0) is the origin)

FIG. 4b shows a magnitude of a reference vector according to a position of a reference point on a coordinate plane in which a focus of expansion is the origin. Specifically, unlike a distance between a focus of expansion and a reference point, a position of a reference point based on a focus of expansion may have a negative value, and thus the Gaussian error function is modified so that a region of in which x values is positive becomes symmetric with respect to the y axis. Accordingly, a magnitude of a reference vector according to an x value of a reference value with respect to the focus of expansion may be expressed by Equation 2.

$$X ( x ) = {\int }_{{x}_{min}}^{{x}_{max}} α * erfc [ - x ( \frac{1}{\sqrt{2}} ) ] \qquad [ Equation 2 ]$$

(X(x): a magnitude of a reference vector according to a position of a reference point with respect to a focus of expansion, erfc: the complementary error function, α: a weight according to a speed of a mobile body, xₘᵢₙ: a minimum value of the reference point existing in a video on the x axis, xₘₐₓ: a maximum value of the reference point existing in the video on the x axis)

As will be described below, a magnitude of a reference vector may be set to reflect a speed of a mobile body. Specifically, with an increase in speed of a mobile body, a magnitude of a reference vector in a video captured in the mobile body may increase. Therefore, in Equation 2, as the speed of the mobile body increases, a value of a may increase.

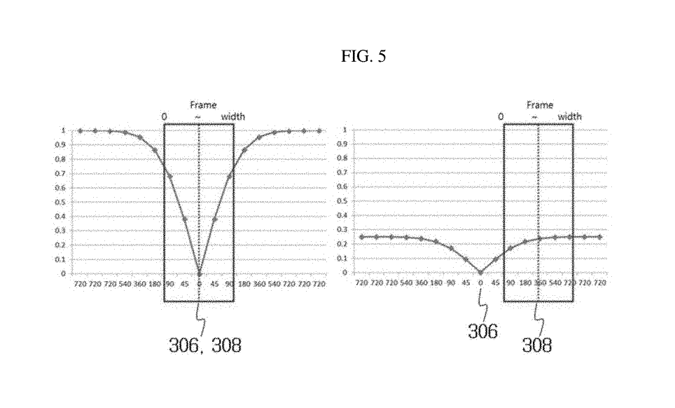

FIG. 5 is a graph showing a relationship between a steering angle of a mobile body and a magnitude of a reference vector and a relationship between a movement speed of a mobile body and the magnitude of a reference vector according to an exemplary embodiment of the present disclosure.

FIG. 5A is a graph showing a magnitude of a reference vector according to a distance between a focus of expansion and a reference point when a steering angle of a mobile body is 0. A middle point of the horizontal axis of the graph denotes a focus of expansion 306, and the vertical axis of the graph denotes a magnitude of a reference vector. Also, a rectangular frame denotes a range in which a video is displayed, and a dotted vertical line in the frame may be a center 308 of the video. According to the exemplary embodiment shown in FIG. 5A, since the focus of expansion 306 is at the center 308 of the video, it is possible to see that the mobile body is moving straight ahead. In other words, a steering angle of the mobile body is 0. Therefore, in the above-described exemplary embodiment, a magnitude of a reference vector with respect to a reference point at the edge of the video may be greater than a magnitude of a reference vector with respect to the center 308 of the video.

FIG. 5B is a graph showing a magnitude of a reference vector according to a distance between a focus of expansion 306 and a reference point 310 when a steering angle of a mobile body is 360. A middle point of the horizontal axis of the graph denotes the focus of expansion 306, and the vertical axis of the graph denotes a magnitude of a reference vector. A rectangular frame denotes a range in which a video is displayed. Specifically, with an increase in steering angle of the mobile body, the focus of expansion 306 deviates from the video. As shown in FIG. 5B, since a reference vector of a reference point on the left of the center of the video is closer to the focus of expansion 306 than a reference vector of a reference point on the right of the center, it is possible to see that a magnitude of the reference vector of the reference point on the left may be less than a magnitude of a reference vector of the reference point on the right.

Meanwhile, it is possible to see that a maximum value of a magnitude of a reference vector in FIG. 5A is greater than a maximum value of a magnitude of a reference vector in FIG. 5B. As described above, when a movement speed of a mobile body is higher, a distance that a reference point 310 moves in a video per unit time, that is, a magnitude of a reference vector, may increase. For this reason, it is possible to see that a mobile body of FIG. 5A is moving at a higher speed than a mobile body of FIG. 5B.

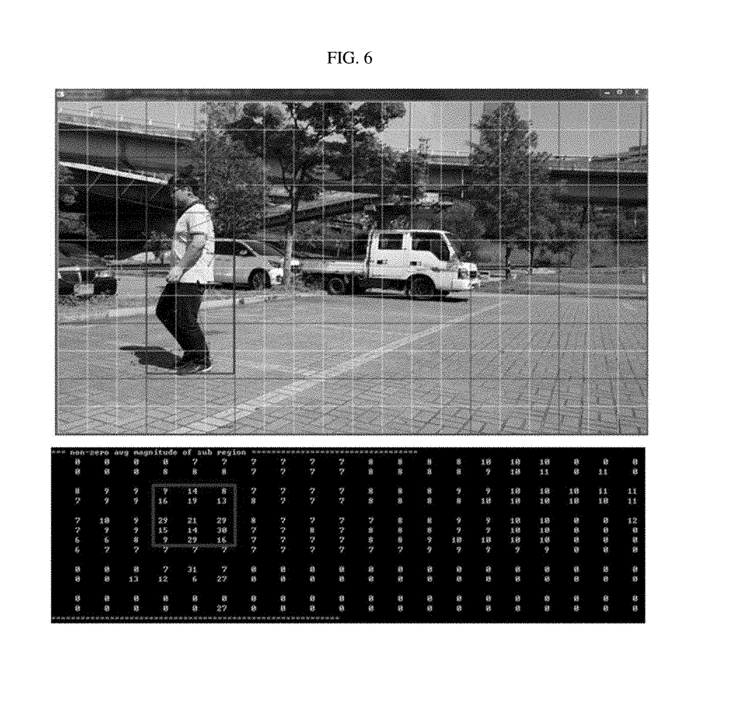

FIG. 6 is an example view illustrating a method of detecting an object using the object-detecting apparatus 100 according to an exemplary embodiment of the present disclosure.

The video (up) of FIG. 6 is an example view of a video of a walking pedestrian obtained in a moving mobile body. In the video, motion vectors of the pedestrian and a target region with respect to a background are displayed.

The data (down) of FIG. 6 is a set of magnitude data of the motion vectors according to positions in the video. The box shown in the data denotes a data region corresponding to a region of the pedestrian in the video. Comparing the magnitudes of the motion vectors with magnitudes of motion vectors extracted from other sub-regions in the target region, it is possible to see that there is a remarkable difference therebetween. For example, magnitudes of motion vectors extracted from a tree corresponding to a fixed reference point in the target region have values of 7 to 10. On the other hand, magnitudes of motion vectors extracted from the pedestrian who is moving have values of 14 to 30. Even during a drive, the object-detecting apparatus 100 may efficiently detect an object which is likely to collide with the mobile body using a difference in positional change between an object and a background.

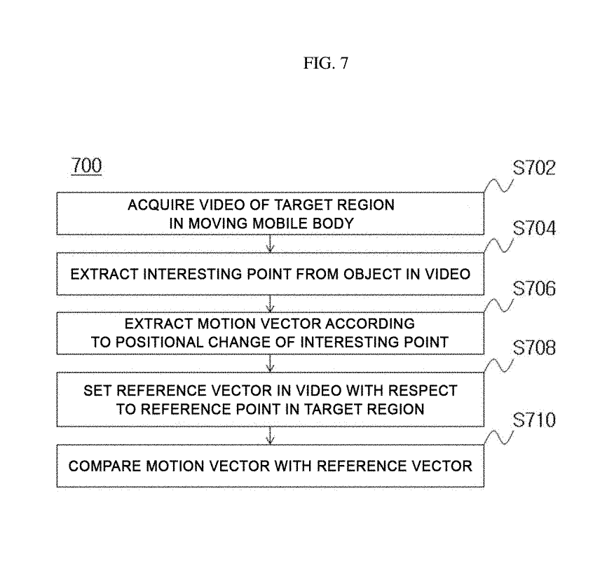

FIG. 7 is a flowchart illustrating a method 700 of detecting an object according to an exemplary embodiment of the present disclosure. The method 700 illustrated in FIG. 7 may be performed by, for example, the object-detecting apparatus 100 described above. Although the flowchart illustrates the method 700 divided into a plurality of operations, at least some operations may be performed in a different order, performed in combination with each other, omitted, or performed in sub-operations, or at least one operation not shown in the drawing may be added and performed.

The video acquirer 102 may acquire a video of a target region corresponding to a movement direction of a moving mobile body using an optical module installed in the mobile body (S702).

The motion vector extractor 104 may extract interesting points from one or more objects included in the acquired video (S704). The interesting points represent unique appearances of the objects and may be easily identified even when the objects change in shape, size, or position. For example, the interesting points may be corner points, edges, and the like of the objects.

The motion vector extractor 104 may extract motion vectors of the interesting points according to positional changes of the interesting points in the video caused by a movement of the mobile body (S706). The motion vectors may be movement paths of the interesting points in the video according to the movement of the mobile body.

The reference vector setter 106 may select one or more reference points having fixed positions in the target region and set reference vectors of the reference points according to positional changes of the reference points in the video on the basis of the degree of a turn of the movement direction made by the mobile body (S708). According to an exemplary embodiment, it is possible to set a focus of expansion in the video on the basis of the degree of a turn of the movement direction made by the mobile body and set the reference vectors 312 on the basis of distances between the set focus of expansion and the reference points. The focus of expansion may be present in a region to which the mobile body will turn the movement direction from the center of the video.

According to an exemplary embodiment, the reference vector setter 106 may set the reference vectors so that magnitudes of the reference vectors corresponding to the reference points are reduced when the reference points are closer to the focus of expansion in the video. Also, the reference vector setter 106 may set the reference vectors so that the magnitudes of the reference vectors corresponding to the reference points with respect to the distances between the reference points and the focus of expansion in the video are in accordance with a magnitude of the Gaussian error function.

Also, the reference vector setter 106 may set the reference vectors in consideration of a movement speed of the mobile body. According to an exemplary embodiment, the reference vector setter 106 may set the reference vectors so that maximum values of the magnitudes of the reference vectors increase as a speed of the mobile body is higher.

The object detector 108 may detect a moving object in the target region among the one or more objects by comparing the extracted motion vectors and the set reference vectors (S710). According to an exemplary embodiment, the object detector 108 may detect the moving object by comparing magnitudes of the extracted motion vectors and magnitudes of the reference vectors corresponding to positions of the motion vectors in the video. Specifically, the object detector 108 may set an object corresponding to an extracted motion vector as the moving object when a difference between a magnitude of the extracted motion vector and a magnitude of a reference vector corresponding to a position of the motion vector in the video is a set value or more.

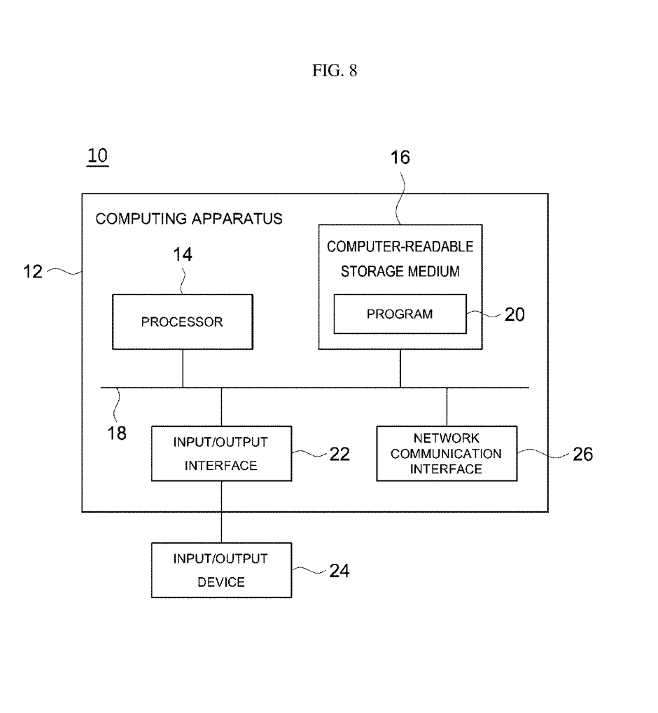

FIG. 8 is a block diagram illustrating a computing environment 10 including a computing apparatus appropriate for use in the exemplary embodiments. In the exemplary embodiment shown in the drawing, each of the components may have a function and a capability other than those described below, and an additional component other than the components described below may be included.

The computing environment 10 shown in the drawing includes a computing apparatus 12. In an exemplary embodiment, the computing apparatus 12 may be the object-detecting apparatus 100.

The computing apparatus 12 includes at least one processor 14, a computer-readable storage medium 16, and a communication bus 18. The processor 14 may cause the computing apparatus 12 to operate according to the above-described exemplary embodiments. For example, the processor 14 may execute one or more programs stored in the computer-readable storage medium 16. The one or more programs may include one or more computer-executable instructions, which may be configured to cause the computing apparatus 12 to perform operations according to an exemplary embodiment when executed by the processor 14.

The computer-readable storage medium 16 is configured to store computer-executable instructions or program codes, program data, and/or information in other appropriate forms. A program 20 stored in the computer-readable storage medium 16 includes a set of instructions executable by the processor 14. In an exemplary embodiment, the computer-readable storage medium 16 may be a memory (a volatile memory such as a random access memory (RAM), a non-volatile memory, or an appropriate combination thereof), one or more magnetic disk storage devices, optical disk storage devices, flash memory devices, another form of storage medium which is accessible by the computing apparatus 12 and capable of storing desired information, or an appropriate combination thereof.

The communication bus 18 connects various other components of the computing apparatus 12 including the processor 14 and the computer-readable storage medium 16 to each other.

The computing apparatus 12 may also include one or more input/output interfaces 22 for one or more input/output devices 24 and one or more network communication interfaces 26. The input/output interfaces 22 and the network communication interfaces 26 are connected to the communication bus 18. The input/output devices 24 may be connected to other components of the computing apparatus 12 via the input/output interfaces 22. Examples of the input/output devices 24 may include input devices, such as a pointing device (a mouse, a trackpad, and the like), a keyboard, a touch input device (a touchpad, a touch screen, and the like), a voice or sound input device, various types of sensor devices, and/or a photographing device, and/or output devices, such as a display device, a printer, a speaker, and/or a network card. Examples of the input/output devices 24 may be included in the computing apparatus 12 as components constituting the computing apparatus 12, or may be connected to the computing apparatus 12 as separate devices distinguished from the computing apparatus 12.

According to exemplary embodiments of the present disclosure, it is possible to easily detect, in a video of a target region, an object which is likely to collide with a mobile body by comparing positional changes of a background and a moving object in the target region.

Further, according to exemplary embodiments of the present disclosure, it is possible to accurately detect an object at low costs by analyzing a movement of a background in a video on the basis of at least one of a movement speed and a steering angle of a mobile body.

Although exemplary embodiments of the present disclosure have been described in detail above, those of ordinary skill in the art to which the present disclosure pertains will appreciate that various modifications may be made without departing from the scope of the present disclosure. Therefore, the scope of the present disclosure is to be determined by the following claims and their equivalents, and is not restricted or limited by the foregoing detailed description.

What is claimed is:

1. An apparatus for detecting an object, the apparatus comprising:
a processor configured to execute processor-executable instructions to:
acquire a video of a target region corresponding to a movement direction of a mobile body;
extract one or more interesting points of one or more objects in the video acquired and extract one or more motion vectors according to positional changes of the one or more interesting points in the video;
select one or more reference points having fixed positions in the target region and set one or more reference vectors of the one or more reference points, respectively, according to positional changes of the one or more reference points in the video; and
detect a moving object among the one or more objects in the video by comparing the one or more motion vectors extracted with the one or more reference vectors set.

2. The apparatus of claim 1, wherein the processor is further configured to:
set a focus of expansion in the video based on a degree of a turn of the movement direction made by the mobile body, and
set the one or more reference vectors based on distances between the focus of expansion and the one or more reference points.

3. The apparatus of claim 2, wherein the processor is further configured to decrease magnitudes of the one or more reference vectors of the one or more reference points in response to the distance between the focus of expansion and the one or more reference points decreasing.

4. The apparatus of claim 2, wherein magnitudes of the one or more reference vectors of the one or more reference points correspond to magnitudes of a Gaussian error function.

5. The apparatus of claim 1, wherein the processor is further configured to set the one or more reference vectors to correspond to a movement speed of the mobile body.

6. The apparatus of claim 1, wherein the processor is further configured to detect the moving object by comparing magnitudes of the one or more motion vectors extracted and magnitudes of the one or more reference vectors set corresponding to positions of the one or more motion vectors, respectively.

7. The apparatus of claim 1, wherein the processor is further configured to set the one or more reference vectors, wherein maximum values of magnitudes of the one or more reference vectors correspond to a speed of the mobile body.

8. The apparatus of claim 1, wherein the processor is further configured to detect an object corresponding to an extracted motion vector as the moving object when a difference between a magnitude of the extracted motion vector and a magnitude of a reference vector corresponding to a position of the motion vector in the video is equal to or higher than a predetermined value.

9. A method for detecting an object, the method comprising:
acquiring a video of a target region corresponding to a movement direction of a mobile body;
extracting one or more interesting points of one or more objects in the video, and extracting one or more motion vectors according to positional changes of the one or more interesting points in the video;
selecting one or more reference points having fixed positions in the target region, and setting one or more reference vectors of the one or more reference points, respectively, according to positional changes of the one or more reference points in the video; and
detecting a moving object among the one or more objects in the video by comparing the one or more motion vectors with the one or more reference vectors.

10. The method of claim 9, further comprising:
setting a focus of expansion in the video based on a degree of a turn of the movement direction made by the mobile body, and
setting the one or more reference vectors based on distances between the focus of expansion and the one or more reference points.

11. The method of claim 10, further comprising setting the magnitudes of the one or more reference vectors of the one or more reference points to correspond to the distances between the focus of expansion and the one or more reference points.

12. The method of claim 10 further comprising setting magnitudes of the one or more reference vectors to correspond to magnitudes of a Gaussian error function.

13. The method of claim 9, further comprising setting the one or more reference vectors to correspond to a movement speed of the mobile body.

14. The method of claim 9, further comprising detecting the moving object by comparing magnitudes of the one or more motion vectors and magnitudes of the one or more reference vectors corresponding to positions of the one or more motion vectors, respectively.

15. The method of claim 9, wherein maximum values of magnitudes of the one or more reference vectors correspond to a speed of the mobile body.

16. The method of claim 9, further comprising detecting an object corresponding to an extracted motion vector as the moving object when a difference between a magnitude of the extracted motion vector and a magnitude of a reference vector corresponding to a position of the motion vector in the video is equal to or higher than a predetermined value.
